(19) United States
(12) Patent Application Publication
(10) Pub. No.: US 2011/0095684 A1
(43) Pub. Date: Apr. 28, 2011

(54) Excimer lamp

(75) Inventors: Kengo Moriyasu, Hyogo (JP); Fumihiko Oda, Hyogo (JP)

(73) Assignee: USHIO DENKI KABUSHIKI KAISHA, Tokyo (JP)

(21) Appl. No.: 12/926,019

(22) Filed: Oct. 21, 2010

(30) Foreign Application Priority Data
Oct. 23, 2009 (JP) 2009-244187

(51) Int. Cl. H01J 61/12

(52) U.S. Cl. 313/637

(57) ABSTRACT

An excimer lamp that has an arc tube in which a seal structure is formed using a metal brazing material, which is composed of gold or a gold-nickel alloy, at an end portion of a transparent ceramic pipe that encloses a gas containing rare gas and fluorine atoms and a pair of electrodes arranged outside the arc tube.

### CROSS-REFERENCES TO RELATED APPLICATION

This application claims priority from Japanese Patent Application Serial No. 2009-244187 filed Oct. 23, 2009, the contents of which are incorporated herein by reference in their entirety.

### TECHNICAL FIELD

The present invention relates to an excimer lamp that encloses fluorine, as an electric discharge substance.

### BACKGROUND

It is known that in an excimer lamp, an arc tube, which serves as dielectrics, is arbitrarily filled up with light emission gas and halogen, wherein excimer molecules are generated in the arc tube by dielectric barrier discharge, so that excimer light is emitted from the excimer molecules. In such an excimer lamp, rare gas (argon, krypton, xenon, etc.) and fluorine are enclosed as electric discharge gas depending on the wavelength of excimer light to be obtained. For example, light whose wavelength is 193 nm is emitted in case of electric discharge gas which consists of argon-fluorine gas, light whose wavelength is 248 nm is emitted in case of electric discharge gas, which consists of krypton-fluorine gas, and light whose wavelength is 351 nm is emitted in case of an electric discharge gas, which consists of xenon-fluorine gas. For example, Japanese Patent Application Publication No. 2009-176459 discloses such an excimer lamp, which is used in a wide variety of fields, such as a characteristic test of a photo-sensitive film, circumference exposure, and a mask examination.

In such an excimer lamp which contains fluorine in an arc tube, since fluorine ions generated during electric discharge have high reactivity with silicone (Si), silica glass (SiO₂) cannot be used as material of the arc tube. For this reason, material, which does not contain silicone (Si) and which consists of material with small absorption of the fluorine ions, is used for the arc tube, so that, for example, metal oxide, such as alumina (polycrystalline alumina) or sapphire (single crystal alumina) whose main component is aluminum oxide (Al₂O₃), is used as material of the arc tube.

FIG. 4 shows the structure of an excimer lamp of prior art. Since silica glass cannot be used for an arc tube 81, as mentioned above, a straight tube shaped ceramic pipe 82, which is transparent, is used for a main body portion. Specifically, the arc tube 81 consists of sapphire, YAG, single crystalline yttria, or the like. To seal the ceramic pipe, after a metalization layer is formed on an outer circumferential surface at an end portion of the ceramic pipe 82, while Ag—Cu alloy (silver brazing material) is formed thereon, metal brazing material 84, covers caps 83a and 83b, which are made of metal such as nickel, and then heated. When the brazing material 84 melts, the caps 83a and 83b are airtightly brazed to the ceramic pipe 82, forms a seal structure. In such a structure, during a conducting period, fluorine ions do not react with the material of the arc tube, so that it is possible to prolong the usage life of the excimer lamp 80 to, for example, hundreds of hours.

However, the reactivity of fluorine becomes high when the fluorine is ionized during lamp lighting, whereby the consumption is remarkably large. Therefore, the fluorine is depleted with the accumulated lighting time of the lamp, so that illuminance decreases. To satisfy required illuminance maintenance rate, that is, so the fluorine ions may not be depleted, it is considered that the amount of fluorine to be consumed is predicted so that a large amount of a source of fluorine ions are enclosed. However, since gas such as SF₆, CF₄, and NF₃, each of which is a source of fluorine ions, has high chemical stability and has a high electron attachment nature (in other words, it has the strong electron capture property), so that it catches electrons produced by ionization with high probability, the gas electric discharge (SF₆, CF₄, and NF₃) itself suppresses formation of electric discharge and if it is enclosed to exceed the optimal range, the efficiency worsens. Specifically, when the enclosed amount of the fluorine ion source is simply made high, in case where the condition is the same as that in a lamp input, there is a problem that the illuminance of an irradiated area becomes low. Therefore, although it is considered that there is a merit in view of prolonging the usage life span of the lamp when the enclosed amount of the source of fluorine ions is increased, this causes deterioration in the efficiency, so that it does not create a fundamental solution.

Of course, if only consumption of the fluorine ions can be suppressed, there is no problem. Although the causes of consumption of the fluorine ions are studied, a rapid change of illuminance has not been improved and its cause has not been identified.

### SUMMARY

The present invention relates to an excimer lamp that comprises an arc tube in which a seal structure is formed using metal brazing material at an end portion of a transparent ceramic pipe and that encloses a gas of rare gas and fluorine atoms; and a pair of electrodes arranged outside the arc tube, wherein the metal brazing material is composed of gold or a gold-nickel alloy.

Further, the mass fraction of a nickel component in the metal brazing material made of gold-nickel alloy may be 35 wt % or less.

Furthermore, the mass fraction of the nickel component in the metal brazing material made of gold-nickel alloy may be in a range of 7-25 wt %.

### BRIEF DESCRIPTION OF THE DRAWINGS

Other features and advantages of the present excimer lamp will be apparent from the ensuing description, taken in conjunction with the accompanying drawings, in which:

FIG. 1A is an explanatory cross sectional view of an excimer lamp according to a first embodiment of the present invention;

FIG. 1B is a cross sectional view of an excimer lamp, taken along a line 1B-1B of FIG. 1A;

FIG. 2 is an enlarged view of a main part of an excimer lamp according to a first embodiment of the present invention;

FIG. 3 shows a result of an experimental example, showing an illuminance maintenance rate; and

FIG. 4 is a perspective view of an excimer lamp of prior art.

### DESCRIPTION

In view of the above-mentioned problem, it is an object of the present invention to offer an excimer lamp capable of suppressing consumption of fluorine ions, while the illuminance and illuminance stability are high. Furthermore, it is an object of the present invention to offer an excimer lamp in which the illuminance of the excimer lamp can be stabilized well without reducing the efficiency, even if gas such as sulfur hexafluoride, carbon tetrafluoride, or nitrogen trifluoride, which is chemically stable, is used as a source of fluorine ions.

An excimer lamp according to the present invention, comprises an arc tube in which a seal structure is formed using metal brazing material (metal brazing material) at an end portion (s) of a transparent ceramic pipe, wherein an arc tube encloses gas containing rare gas and fluorine atoms, and a pair of electrodes, which is arranged outside the arc tube, wherein the metal brazing material is composed of gold or a gold-nickel alloy.

Moreover, the mass fraction of the nickel component in the metal brazing material made of gold-nickel alloy may be 35 wt % or less (however, 0 is not included).

Moreover, the mass fraction of the nickel component in the metal brazing material made of gold-nickel alloy may be in a range of 7-25 wt %.

Effects of the present invention will be described below.

Since the so-called gold brazing material made of Au or Au—Ni alloy is used as the metal brazing material which joins the arc tube and the cap(s) to each other, fluorine (F) and the metal brazing material are hard to react with each other, and consumption of fluorine can be suppressed and the illuminance maintenance rate is good, so that it is possible to offer a nonconventional excimer lamp having a remarkably long life span compared with the prior art.

Furthermore, the temperature at time of brazing may be substantially reduced to the melting point of gold (1,064° C.) or less by lowering the rate of nickel component in Au—Ni alloy brazing to 35 wt % or less.

Furthermore, the temperature at time of brazing may be reduced to 1,000° C. or less by lowering the rate of nickel component in Au—Ni alloy brazing to 7-25 wt %.

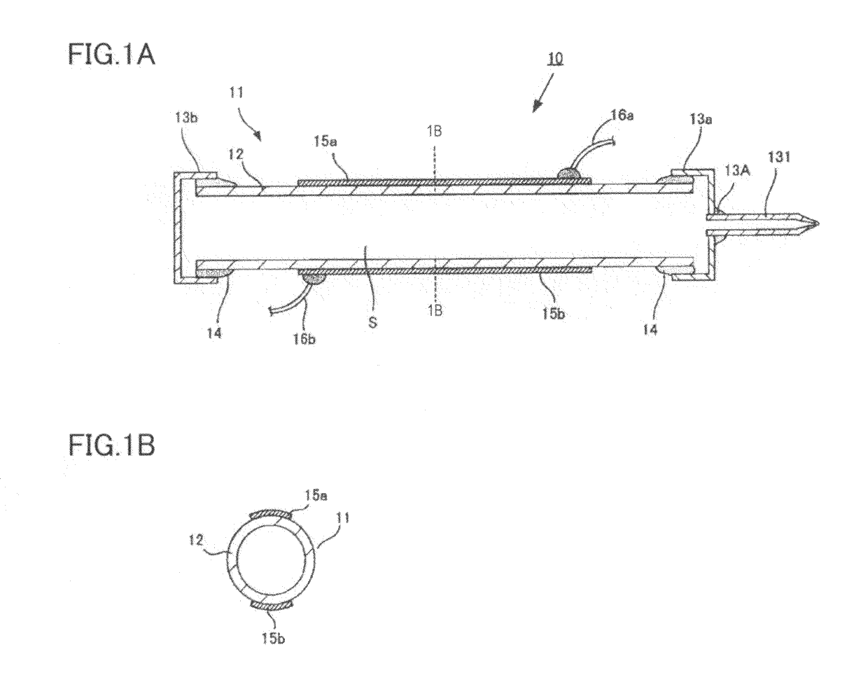

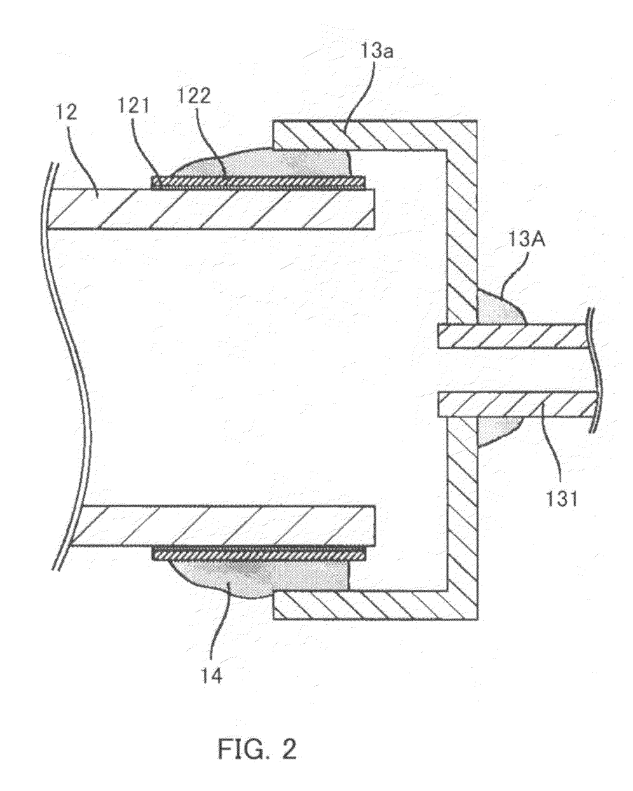

Description of an embodiment of the present invention will be given below referring to FIGS. 1A, 1B and 2. FIG. 1B is a cross sectional view of an excimer lamp, taken along a tube axis direction according to the present invention. FIG. 1B is a cross sectional view of the excimer lamp taken along the line 1B-1B of FIG. 1A. Moreover, FIG. 2 is an enlarged view of a seal structure formed at one end of the excimer lamp. As shown in the figures, a main body portion of an arc tube in the excimer lamp 10 is made of ceramics whose fluorine ion absorption is low and that has transparency to ultraviolet rays of 150-400 nm. Preferably, it is made of single crystal material, which consists of any one of sapphire, YAG, and single crystalline yttria, or made of polycrystalline alumina and formed in a shape of a straight tube.

In such a transparent ceramic pipe 12 (hereinafter referred to as a “ceramic pipe”), it is desirable to remove metal impurities from an inner face in advance, in a pretreatment for forming an arc tube 11, by performing mechanical grinding processing or chemical etching processing of the inner face using phosphoric acid or sulfuric acid. Furthermore, to reduce the amount of moisture on the wall of the ceramic pipe 12, it is desirable to perform a heat treatment at high temperature of, for example, hundreds degrees or more.

As shown in FIG. 1A sealing caps 13a and 13b, each of which are made from metal cup, are respectively brazed to both ends of the ceramic pipe 12 in a tube axis direction, with metal brazing material (metal brazing material) 14, so that the seal structure forms at the both ends. It is desirable to use nickel (Ni) or alloy whose main component is nickel, and which has high resistance to fluorine, as material of the sealing caps 13a and 13b. In addition, nickel (Ni), whose thermal conductivity is good, is the most suitable among known materials.

One of the caps 13a has an exhaust pipe remaining portion 131. The exhaust pipe remaining portion 131 is used in a manufacturing process of the excimer lamp 10, in which argon (Ar) and sulfur hexafluoride (SF₆), which serve as light emission gas, and helium (He) or neon (Ne), which serve as buffer gas, is enclosed after gas of the inner space of the arc tube 11 is discharged, whereby the arc tube is airtightly sealed by, for example, pressure welding after the predetermined gas is enclosed. Nickel is the most desirable as material of the exhaust pile, for the same reasons as those described above, or it is desirable to use a similar metal with fluorine resistance nature. In addition, such an exhaust pipe is joined to the cap 13a with metal brazing material 13A. The metal brazing material 13A used is the same (similar to) material as metal brazing material 14, which is described below, and it is desirable to use brazing material made of gold or gold-nickel alloy. In addition, description of details of composition of such gold brazing material and gold-nickel alloy, will be explained in detail later.

To certainly perform brazing with the metal brazing material 14, a metalization layer 121 is formed on an outer circumferential surface of base material at an end portion(s) of the ceramic pipe 12, and a plated layer 122 is further formed on the metalization layer 121. A Mo—Mn method is a typical method of forming the metalization layer 121, wherein, for example, paste, which is made by mixing Mo and Mn, is applied on the ceramic pipe 12 and calcinated at high temperature. In this way, a still stronger metal film forms from the plated layer 122 on this metalization layer 121. Especially, nickel is desirable as material of the plated layer 122. This is because it is possible to avoid consumption of fluorine, since a reaction with fluorine ions can be suppressed due to the nickel even when the plated layer 122 is exposed to a space, which is connected to an electrical discharge space S.

The seal structure forms so that the ceramic pipe 12 and the caps 13a and 13b are airtightly brazed by laying the metal brazing material 14 therebetween. The metal brazing material 14 used here is gold brazing material or brazing material made of alloy of gold and nickel (Au—Ni alloy).

Since in the gold brazing material, the melting point of gold is 1,063° C., even when the nickel cap is used, brazing can be performed at temperature sufficiently lower than the melting point of nickel (1,453° C.). Therefore, it is possible to use the gold brazing material without any problem when at least nickel is combined therewith. Of course, other material with high fluorine resistance nature can be used as material of the caps without any problem, as long as the melting point of the material is higher than the melting point of nickel.

Moreover, when the gold-nickel alloy metal brazing material is used, the nickel mass fraction is desirably 35 wt % or less. Since the melting point of the brazing material exceeds 1,100° C. when the rate of nickel exceeds 35 wt %, inevitably the ceramic pipe and caps temperatures have to be maintained to a temperature exceeding 1,100° C. during the brazing process. And if the cap is made of nickel and because it is necessary to heat it to the temperature approximated to the melting point of nickel then when the main body of the cap may be deformed, which would make an airtight seal structure impossible. Moreover, as mentioned above, when the plated layer 122 made of nickel is formed on the metalization layer 121 of the ceramic pipe 12, if it is heated to near the melting point of nickel, there is a possibility that the plated layer 122 diffuses, thereby causing poor brazing. From another point of view, for example, a special electric furnace, which is called silicone carbide (SiC) must be used as a heating body when temperature in brazing exceeds 1,100° C. However, when this temperature is 1,100° C. or less, since heating can be performed by using a comparatively common electric furnace, which uses, for example, a kanthal line for a heating element, an excimer lamp, which is productive, can be realized. On the other hand, when the mass fraction of nickel is specified in a range of 35 wt % or less, even though the cap made of nickel is applied to a seal structure or a plated layer made of nickel is formed, it is possible to certainly seal the excimer lamp without losing mechanical strength. Furthermore, the most desirable mass fraction of nickel is in a range of 7 wt % or more and 25 wt % or less. When the mass fraction is set in this range, it is possible to make the brazing temperature to 1,000° C. or less. Therefore, the quantity of heat (electric power) in a brazing process can be reduced, and it is possible to realize a productive excimer lamp.

As shown in FIGS. 1A and 1B, in the arc tube 11 having the above mentioned seal structure, a pair of external electrodes 15a and 15b, which are apart from each other, is formed to extend along a tube axis direction of the arc tube 11, on an outer surface of the ceramic pipe 12, which is a dielectric. The external electrodes 15a and 15b are formed by applying, for example, copper (Cu) paste, or pasting a plate-shaped aluminum (foil like shape) thereon with an adhesive agent. Of course, the present invention is not limited to such a structure, and other structure may be adopted or combined.

To configure the structure in which electric discharge takes place in only the electrical discharge space S, the shortest creepage distance of the external electrodes 15a and 15b is set to be longer than the shortest distance, which passes through the electrical discharge space S between the external electrode 15a and 15b. Moreover, also prevent creeping discharge in a length direction with conductive components located at an end portion (s) of the arc tube 11, the external electrodes 15a and 15b are arranged to be appropriately apart from the end portion (s) of the arc tube 11. As mentioned above, the metalization layer 121 and the plated layer 122 are formed on the outer circumferential surface of the ceramic pipe 12 at the end portion (s) of the arc tube 11, and the creepage distance with respect to such conductive substances is also taken into consideration.

Each of Leads 16a and 16b for electric supply is electrically connected to an end portion in the longitudinal direction of these external electrodes 15a and 15b by solder. If high frequency high voltage is impressed between the pair of external electrodes 15a and 15b through the leads 16a and 16b at time of lighting of the excimer lamp 10, an electric discharge occurs between the external electrode 15a and 15b through the wall of the ceramic pipe 12 of the arc tube 11. When light emission gas is argon (Ar) and sulfur hexafluoride (SF₆), argon ions and fluorine ions are formed by ionization so that argon-fluorine excimer molecules are formed, whereby light with wavelength of 193 nm is emitted from the transparent portion of the arc tube 11.

As described above, in the excimer lamp, since the fluorine ions generated at time of lamp lighting have high reactivity, high fluorine resistance is required for the arc tube material. For this reason, it becomes indispensable to use ceramics, whose reactive property to fluorine is low, for the main body portion of the arc tube in which electric discharge is generated. Although the metal brazing material exists in the space that leads to the electrical discharge space S, it is on the outer circumference of the ceramic pipe, with a small exposed area, so that it was considered that consumption of fluorine ions is irrelevant to the metal brazing material. However, as a result of the inventors' repeating earnest examination, it turns out that the illuminance stability of an excimer lamp can be remarkably improved by using gold brazing or brazing made of gold-nickel alloy, as brazing material.

In the excimer lamp according to the present invention, since gold brazing or brazing made of gold-nickel alloy is used as metal brazing material, and the brazing material has a fluorine resistance nature while its reactivity to fluorine is poor, it is possible to suppress consumption of fluorine due to reaction of fluorine ions, which are generated during electric discharge, with the metal brazing material, so that decrease of light emission intensity due to the consumption of fluorine can be suppressed. Thus, it is possible to maintain high illuminance maintenance rate. Therefore, even where gas which has high scientific stability and which has property preventing electric discharge by enclosing it, for example, sulfur hexafluoride (SF₆), is selected as a fluorine ion source, and the enclosed gas amount can be determined in a range in which the efficiency of the lamp becomes optimal, so that the lamp efficiency can be improved, whereby an excimer lamp, in which the stability of illuminance is good, and the life span is remarkably longer than that of the prior art.

### Embodiment

According to the structure shown in FIG. 1, an excimer lamp was made. A straight tube shaped ceramic tube made of sapphire (12), in which the outer diameter of the lamp was φ10 mm, the inner diameter was φ8 mm, and the full length was 120 mm, was used. Both end portions of the ceramic tube were respectively covered by sealing caps (13a, 13b) made of nickel using the metal brazing material (14), which consists of gold-nickel alloy brazing material (Au: 82 wt %, Ni: 18 wt % Ni alloy, and melting point: 950° C.), so that they were airtightly joined. Air was discharged from the inside of the arc tube (11) by using a nickel exhaust pipe (131), to which the one cap (13a) was connected, and then predetermined light emission gas was enclosed. The above-mentioned gold-nickel alloy brazing material (the same composition) was also used as the metal brazing material (13A) to join the cap (13a) and the exhaust pipe (131). Argon gas (99.9%), as rare gas, and sulfur hexafluoride (SF₆) (0.1%), as gas that contains fluorine atoms, was used as light emission gas, wherein the total enclosure pressure was set to 25 kPa. The exhaust pipe (131) was cut off while maintaining the pressure by pressure welding after gas was enclosed. A pair of external electrodes (15a, 15b) was formed on an outer circumferential surface of the ceramic tube (12), so as to extend in a length direction of the tube (12), thereby making an “excimer lamp 1” according to the present invention. In addition, the external electrodes (15a, 15b) were formed from sintered gold.

### REFERENCE EXAMPLE

An excimer lamp 2 was made in which the specification of the excimer lamp 2 is the same as that of the excimer lamp 1, except that silver brazing material (Ag: 72 wt %, Cu alloy: 28 wt %) was used as metal brazing material for joining the ceramic tube and the caps.

### EXPERIMENTAL EXAMPLE

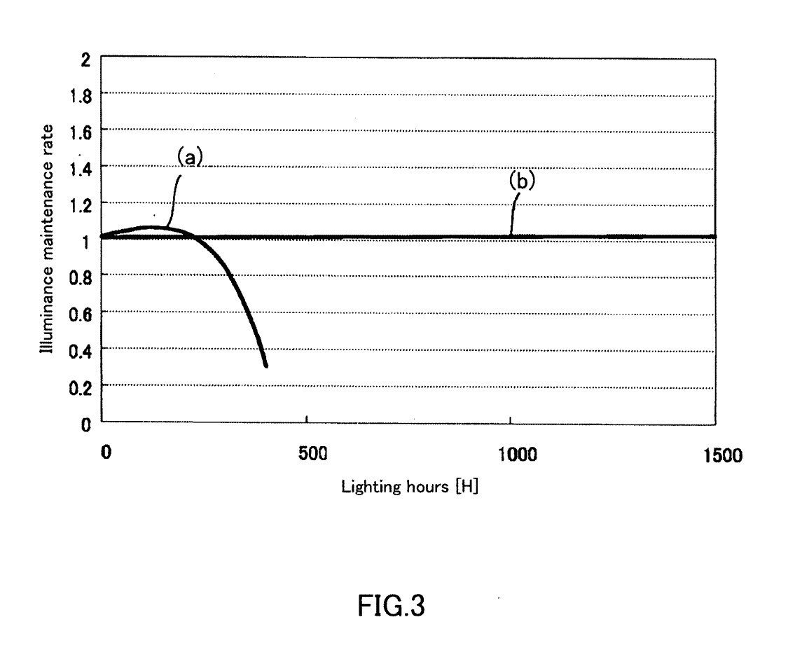

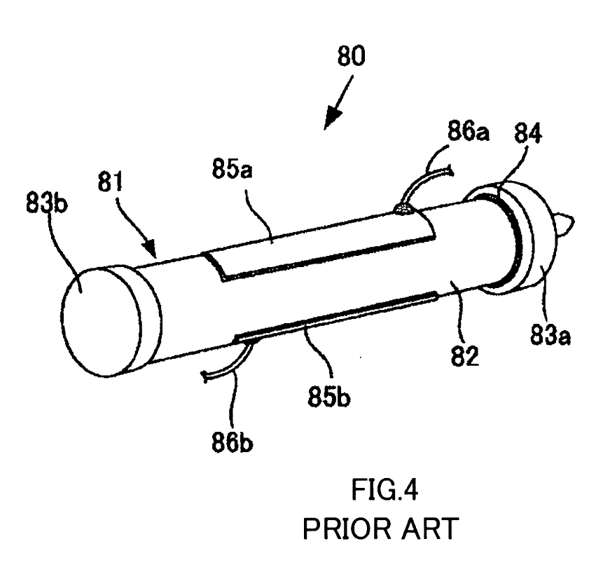

High-frequency voltage was impressed between the electrodes of the above-mentioned excimer lamps 1 and 2 respectively, to induce dielectric barrier discharge, thereby obtaining light with wavelength of 193 nm. The result is shown in FIG. 3. In addition, in FIG. 3, a vertical axis shows illuminance maintenance rate (relative value), and an abscissa axis shows time (hour). Illuminance was measured using an illuminometer, which had a wave length sensibility of 193 nm. In the figure, the relative values are shown where illuminance at time of initial lighting was set as 1.0. Moreover, in the figure, a curve line (a) shows a result of the illuminance maintenance rate of the excimer lamp 1, and a curve line (b) shows a result of the illuminance maintenance rate of the excimer lamp 2, respectively.

In the excimer lamp 2 (Ag—Cu system brazing material was used) according to the Reference Example 1, it took hundreds of hours for the illuminance to become half the initial value or lower. The illuminance was low in an early stage of the lamp due to existence of the sulfur hexafluoride (SF₆), which was a fluorine ion source, and when the illuminance rose and reached a peak after the lamp was turned on, it decreased rapidly. Thus, it is presumed that the instability of illuminance was attributed to the consumption of fluorine. That is, in this excimer lamp 2, the efficiency of the lamp is considered to be the best when the fluorine concentration (sulfur hexafluoride (SF₆)) at which the illuminance reaches the peak value. However, to obtain the required illuminance for a long time, the gas containing fluorine atoms was enclosed superfluously and the supply source of fluorine ions must be provided. On the other hand, when sulfur hexafluoride (SF₆) is used as the gas containing fluorine atoms, formation of electric discharge is inhibited and the illuminance in an early stage of lamp lighting drops. Consequently, with consumption of fluorine (namely, consumption of SF₆), the efficiency of electric discharge is improved so that the illuminance is improved. In other words, in this excimer lamp 2, it was necessary to sacrifice the lamp efficiency in an early stage of lamp lighting to prolong the lamp life span.

Unlike the experimental result according to the reference example, in the excimer lamp 1 (Au—Ni brazing material was used) according to the embodiment of the present invention, there is no rapid change in the illuminance, and even if the lamp was lighted for 1,000 hours or more, illuminance change was stable within ±0.5, and further it turned out that the required illuminance could be obtained. This means that a reaction of the metal brazing material and the fluorine ions is suppressed, so that consumption of fluorine can be reduced, whereby the light emission gas in the arc tube was maintained in condition almost equal to that in an early stage of lamp lighting.

The embodiments according to the present invention are explained above. As mentioned above, according to the present invention, in the excimer lamp in which at least fluorine is enclosed as light emission gas, and a sealing structure using metal brazing material is formed at an end portion(s) of a transparent ceramic tube, it becomes possible to remarkably prolong a lamp life span, as compared with the prior art, by using gold or a gold-nickel alloy as metal brazing material. Further, good illuminance stability is obtained, and it is possible to appropriately adjust the amount of gas including fluorine atoms, whereby the efficiency of the lamp can be remarkably improved. In addition, in the present invention, materials of the structure, for example, the caps, the ceramic tube, and the exhaust pipe, except for the metal brazing material, are not limited to those described as an example above, and it can be suitably changed.

The preceding description has been presented only to illustrate and describe exemplary embodiments of the present excimer lamp. It is not intended to be exhaustive or to limit the invention to any precise form disclosed. It will be understood by those skilled in the art that various changes may be made and equivalents may be substituted for elements thereof without departing from the scope of the invention. In addition, many modifications may be made to adapt a particular situation or material to the teachings of the invention without departing from the essential scope. Therefore, it is intended that the invention not be limited to the particular embodiment disclosed as the best mode contemplated for carrying out this invention, but that the invention will include all embodiments falling within the scope of the claims. The invention may be practiced otherwise than is specifically explained and illustrated without departing from its spirit or scope.

What is claimed is:

1. An excimer lamp, comprising:
an arc tube in which a seal structure is formed using a metal brazing material at an end portion of a transparent ceramic pipe and that encloses a gas of rare gas and fluorine atoms; and
a pair of electrodes arranged outside the arc tube,
wherein the metal brazing material is composed of gold or a gold-nickel alloy.

2. The excimer lamp according to claim 1, wherein amass fraction of a nickel component in the metal brazing material made of gold-nickel alloy is 35 wt % or less.

3. The excimer lamp according to claim 2, wherein the mass fraction of the nickel component in the metal brazing material made of gold-nickel alloy is in a range of 7-25 wt %.
